(19) United States
(12) Patent Application Publication
(10) Pub. No.: US 2026/0213101 A1
(43) Pub. Date: Jul. 23, 2026

(54) POWER SUPPLY SWITCHING DEVICE

(71) Applicant: OMRON Corporation, Kyoto-shi, Kyoto (JP)

(72) Inventors: Naoki KAWAGUCHI, Kyoto-shi, Kyoto (JP); Yasuo HAYASHIDA, Kyoto-shi, Kyoto (JP)

(21) Appl. No.: 19/132,823

(22) PCT Filed: Nov. 16, 2023
(86) PCT No.: PCT/JP2023/041215

§ 371 Date: May 26, 2025

(30) Foreign Application Priority Data
Dec. 28, 2022 (JP) 2022-212764

(51) Int. Cl. H01H 47/00; H02J 3/007; H02J 9/06

(52) U.S. Cl. CPC H01H 47/005; H02J 3/007; H02J 9/062; H02J 9/068; H01H 2300/018

(57) ABSTRACT

A power supply switching device includes main power, auxiliary power, and load circuits, and power supply and load side relays. The power supply side relay includes first and second main and auxiliary power contacts. In the first main connection state, the power supply side relay connects the first and second main power contacts and disconnects the auxiliary ones. In the second main connection state, the power supply side relay connects the first and second auxiliary power contacts and disconnects the main power ones. The load side relay includes third main and auxiliary power contacts. In the second main connection state, the load side relay connects the third main power contact and load circuit and disconnects the third auxiliary ones. In the second auxiliary connection state, the load side relay connects the third auxiliary power contact and the load circuit and disconnects the third main power contact and the load circuit.

### CROSS-REFERENCE TO RELATED APPLICATIONS

This application is the U.S. National Phase of International Application No. PCT/JP2023/041215, filed on Nov. 16, 2023, the priority benefit of which is claimed. International Application No. PCT/JP2023/041215 claims priority to Japanese Patent Application No. 2022-212764, filed Dec. 28, 2022, the priority benefit of which is claimed. The contents of both those applications are incorporated by reference herein in their entireties.

### FIELD

The claimed invention relates to a power supply switching device.

### BACKGROUND

A power supply switching device that switches a power supply to a load is conventionally known. For example, Japanese Patent Application Publication No. 2021-132495 discloses a power supply switching system that switches the power supply to a load from a commercial power supply to the other power supply when the commercial power supply experiences a power outage. This power supply switching system includes first to fourth relays. The a-contact of the first relay is connected to a commercial power supply. The a-contact of the second relay is connected to the other power supply. The other power supply includes a battery and a distributed power supply. The a-contact of the third relay is connected to the battery. The a-contact of the fourth relay is connected to the distributed power supply. The power supply connected to the load is switched by switching the a-contacts of the first to fourth relays on/off.

### SUMMARY

In the above power supply switching system, if the contacts melt, the power supply will be short-circuited. For example, if the a-contacts of the second and third relays are switched on while the a contact of the first relay is in a welded state, a short circuit will occur between the main power supply and the battery. An object of the claimed invention is to prevent a short circuit between power supplies when contacts are welded in a power supply switching device that switches between a plurality of power supplies.

A power supply switching device according to one aspect of the claimed invention switches a power supply of a load between a main power supply and an auxiliary power supply. The power supply switching device includes a main power circuit, an auxiliary power circuit, a load circuit, a power supply side relay, a main connecting circuit, an auxiliary connecting circuit, and a load side relay. The main power circuit is connected to the main power supply. The auxiliary power circuit is connected to the auxiliary power supply. The load circuit is connected to the load. The power supply side relay includes a first main power contact, a second main power contact, a first auxiliary power contact, and a second auxiliary power contact. The first main power contact is connected to the main power circuit. The second main power contact is disposed corresponding to the first main power contact. The first auxiliary power contact is connected to the auxiliary power circuit. The second auxiliary power contact is disposed corresponding to the first auxiliary power contact. The power supply side relay is switchable between a first main connection state and a first auxiliary connection state. In the first main connection state, the power supply side relay connects the first main power contact and the second main power contact and disconnects the first auxiliary power contact and the second auxiliary power contact. In the second main connection state, the power supply side relay connects the first auxiliary power contact and the second auxiliary power contact and disconnects the first main power contact and the second main power contact. The main connecting circuit is connected to the second main power contact. The auxiliary connecting circuit is connected to the second auxiliary power contact. The load side relay includes a third main power contact and a third auxiliary power contact. The third main power contact is connected to the main connecting circuit. The third auxiliary power contact is connected to the auxiliary connecting circuit. The load side relay is switchable between a second main connection state and a second auxiliary connection state. In the second main connection state, the load side relay connects the third main power contact and the load circuit and disconnects the third auxiliary power contact and the load circuit. In the second auxiliary connection state, the load side relay connects the third auxiliary power contact and the load circuit and disconnects the third main power contact and the load circuit.

In the power supply switching device of the present aspect, if welding of the contacts occurs in the power supply side relay, the power supply side relay will be unable to switch between the first main connection state and the first auxiliary connection state, but the load side relay can be switched between the second main connection state and the second auxiliary connection state. In addition, if welding of the contacts occurs in the load side relay, the load side relay will be unable to switch between the second main connection state and the second auxiliary connection state, but the power supply side relay can be switched between the first main connection state and the first auxiliary connection state. This prevents the power supply from being shorted out.

The power supply switching device may further include a controller that controls the power supply side relay and the load side relay. The controller may cause power to be supplied from the main power supply to the load by switching the power supply side relay to the first main connection state and switching the load side relay to the second main connection state.

The controller may switch the load side relay to the second main connection state after a predetermined time has elapsed after switching the power supply side relay to the first main connection state. In this case, the occurrence of an arc in the power supply side relay is suppressed. The controller may switch the power supply side relay to the first main connection state after a predetermined time has elapsed after switching the load side relay to the second main connection state. In this case, the occurrence of an arc in the load side relay is suppressed.

The controller may cause the auxiliary power supply to supply power to the load by switching the power supply side relay to the first auxiliary connection state and switching the load side relay to the second auxiliary connection state. The controller may switch the load side relay to the second auxiliary connection state after a predetermined time has elapsed after switching the power supply side relay to the first auxiliary connection state. In this case, the occurrence of an arc in the power supply side relay is suppressed. The controller may switch the power supply side relay to the first auxiliary connection state after a predetermined time has elapsed after switching the load side relay to the second auxiliary connection state. In this case, the occurrence of an are in the load side relay is suppressed.

The power supply switching device may further include a main power sensor that detects a voltage or current of the main power circuit. The controller may determine welding of at least one of the first main power contact, the second main power contact, and the third main power contact based on the voltage or current in the main power circuit detected by the main power sensor. In this case, the occurrence of welding of the contacts can be detected.

The power supply switching device may further include an auxiliary power sensor that detects a voltage or current of the auxiliary power circuit. The controller may determine welding of at least one of the first auxiliary power contact, the second auxiliary power contact, and the third auxiliary power contact based on the voltage or current in the auxiliary power circuit detected by the auxiliary power sensor. In this case, the occurrence of welding of the contacts can be detected.

### BRIEF DESCRIPTION OF THE DRAWINGS

FIG. 1 is a schematic diagram showing a configuration of a power supply switching device.

FIG. 2 is an enlarged view of the power supply switching device in a main connection state.

FIG. 3 is an enlarged view of the power supply switching device in an auxiliary connection state.

FIG. 4 is a schematic diagram showing a configuration of the power supply switching device.

FIG. 5 is a timing chart showing control of a power supply side relay and a load side relay when switching between power supplies.

FIG. 6 is a diagram showing a connection state of the power supplies of the power supply switching device when welding of a contact occurs in the first power supply side relay.

FIG. 7 is a diagram illustrating a power supply switching device according to a first modified example.

FIG. 8 is a diagram illustrating a power supply switching device according to a second modified example.

FIG. 9 is a diagram illustrating a power supply switching device according to a third modified example.

FIG. 10 is a diagram illustrating a power supply switching device according to a fourth modified example.

### DETAILED DESCRIPTION

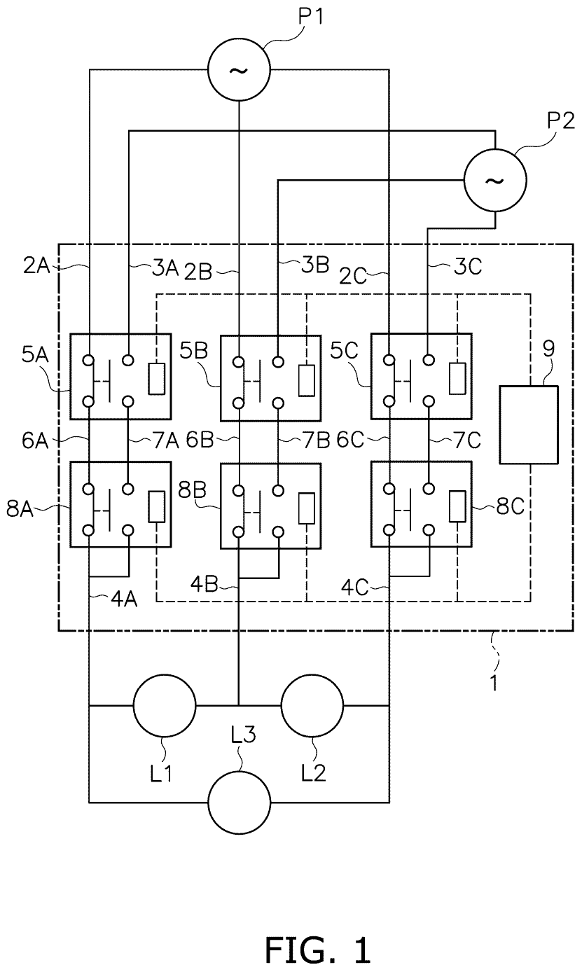

A power supply switching device according to an embodiment of the claimed invention will be described below with reference to the drawings. FIG. 1 is a schematic diagram showing a configuration of a power supply switching device 1 according to an embodiment. As shown in FIG. 1, the power supply switching device 1 is connected to loads L1-L3, a main power supply P1, and an auxiliary power supply P2. The main power supply P1 is, for example, a commercial power supply. The auxiliary power supply P2 is used in place of the main power supply P1 when the main power supply P1 experiences a power outage. The auxiliary power supply P2 is, for example, a battery or a generator. The loads L1-L3 are electrical devices that receive power from the main power supply P1 or the auxiliary power supply P2. The power supply switching device 1 switches the power supply of the loads L1-L3 between the main power supply P1 and the auxiliary power supply P2.

The power supply switching device 1 includes main power circuits 2A-2C, auxiliary power circuits 3A-3C, load circuits 4A-4C, power supply side relays 5A-5C, main connecting circuits 6A-6C, auxiliary connecting circuits 7A-7C, load side relays 8A-8C, and a controller 9. The main power circuits 2A-2C are connected to the main power supply P1. The main power circuits 2A-2C include a first main power circuit 2A, a second main power circuit 2B, and a third main power circuit 2C. The auxiliary power circuits 3A-3C are connected to the auxiliary power supply P2. The auxiliary power circuits 3A-3C include a first auxiliary power circuit 3A, a second auxiliary power circuit 3B, and a third auxiliary power circuit 3C. The load circuits 4A-4C are connected to the loads L1-L3. The load circuits 4A-4C include a first load circuit 4A, a second load circuit 4B, and a third load circuit 4C.

The power supply side relays 5A-5C are connected to the main power circuits 2A-2C and the auxiliary power circuits 3A-3C. The power supply side relays 5A-5C include a first power supply side relay 5A, a second power supply side relay 5B, and a third power supply side relay 5C. The first to third power supply side relays 5A to 5C each have a 1a1b type contact structure. The first power supply side relay 5A is connected to the first main power circuit 2A and the first auxiliary power circuit 3A. The second power supply side relay 5B is connected to the second main power circuit 2B and the second auxiliary power circuit 3B. The third power supply side relay 5C is connected to the third main power circuit 2C and the third auxiliary power circuit 3C.

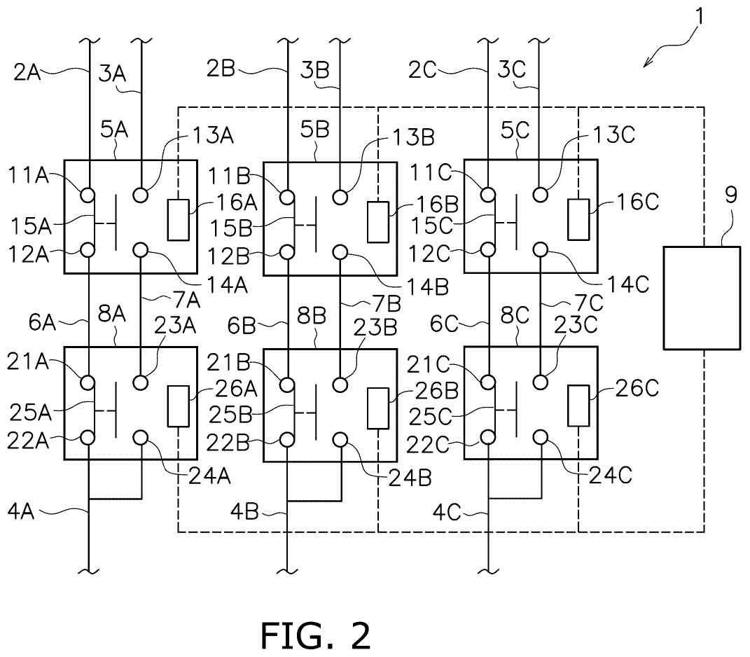

FIG. 2 is an enlarged view of the power supply switching device 1. As shown in FIG. 2, the first power supply side relay 5A includes a first main power contact 11A, a second main power contact 12A, a first auxiliary power contact 13A, a second auxiliary power contact 14A, a first movable piece 15A, and a first coil 16A. The first main power contact 11A is connected to the first main power circuit 2A. The second main power contact 12A is disposed corresponding to the first main power contact 11A. The first auxiliary power contact 13A is connected to the first auxiliary power circuit 3A. The second auxiliary power contact 14A is disposed corresponding to the first auxiliary power contact 13A.

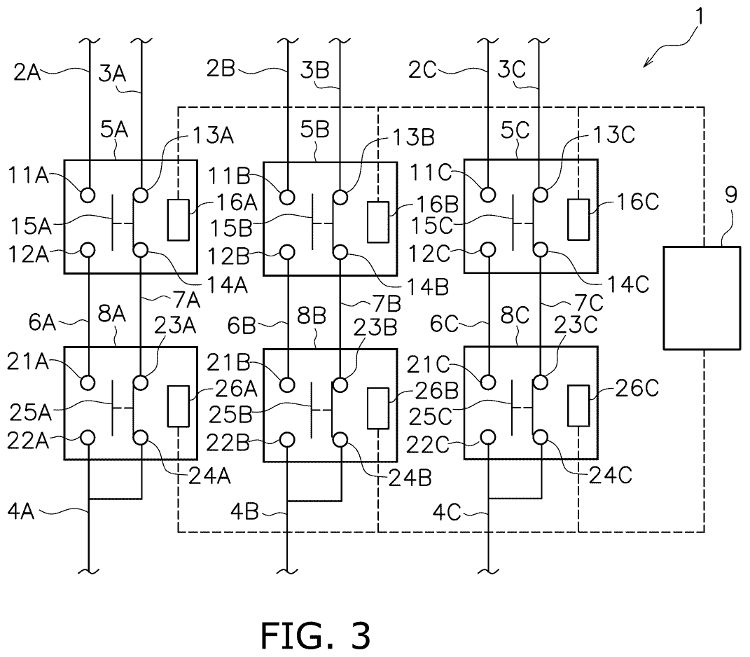

The first movable piece 15A is movable between a main connection position shown in FIG. 2 and an auxiliary connection position shown in FIG. 3. As shown in FIG. 2, in the main connection position, the first movable piece 15A connects the first main power contact 11A and the second main power contact 12A and disconnects the first auxiliary power contact 13A and the second auxiliary power contact 14A. As shown in FIG. 3, in the auxiliary connection position, the first movable piece 15A connects the first auxiliary power contact 13A and the second auxiliary power contact 14A and disconnects the first main power contact 11A and the second main power contact 12A. The first coil 16A selectively moves the first movable piece 15A between the main connection position and the auxiliary connection position by means of a magnetic force.

The first power supply side relay 5A is switchable between a main connection state and an auxiliary connection state. When the first movable piece 15A is disposed in the main connection position, the first power supply side relay 5A is in the main connection state. In the main connection state, the first power supply side relay 5A connects the first main power contact 11A and the second main power contact 12A and disconnects the first auxiliary power contact 13A and the second auxiliary power contact 14A. When the first movable piece 15A is disposed in the auxiliary connection position, the first power supply side relay 5A is in the auxiliary connection state. In the auxiliary connection state, the first power supply side relay 5A connects the first auxiliary power contact 13A and the second auxiliary power contact 14A and disconnects the first main power contact 11A and the second main power contact 12A.

The second power supply side relay 5B and the third power supply side relay 5C have the same configuration as the first power supply side relay 5A. In detail, the second power supply side relay 5B includes a first main power contact 11B, a second main power contact 12B, a first auxiliary power contact 13B, a second auxiliary power contact 14B, a first movable piece 15B, and a first coil 16B. The first main power contact 11B, the second main power contact 12B, the first auxiliary power contact 13B, the second auxiliary power contact 14B, the first movable piece 15B, and the first coil 16B of the second power supply side relay 5B are similar to the first main power contact 11A, the second main power contact 12A, the first auxiliary power contact 13A, the second auxiliary power contact 14A, the first movable piece 15A, and the first coil 16A of the first power supply side relay 5A, respectively.

The third power supply side relay 5C includes a first main power contact 11C, a second main power contact 12C, a first auxiliary power contact 13C, a second auxiliary power contact 14C, a first movable piece 15C, and a first coil 16C. The first main power contact 11C, the second main power contact 12C, the first auxiliary power contact 13C, the second auxiliary power contact 14C, the first movable piece 15C, and the first coil 16C of the third power supply side relay 5C are similar to the first main power contact 11A, the second main power contact 12A, the first auxiliary power contact 13A, the second auxiliary power contact 14A, the first movable piece 15A, and the first coil 16A of the first power supply side relay 5A, respectively.

The main connecting circuits 6A-6C and the auxiliary connecting circuits 7A-7C connect the power supply side relays 5A-5C and the load side relays 8A-8C, respectively. The main connecting circuits 6A-6C include a first main connecting circuit 6A, a second main connecting circuit 6B, and a third main connecting circuit 6C. The auxiliary connecting circuits 7A-7C include a first auxiliary connecting circuit 7A, a second auxiliary connecting circuit 7B, and a third auxiliary connecting circuit 7C. The first main connecting circuit 6A and the first auxiliary connecting circuit 7A are connected to the first power supply side relay 5A. The second main connecting circuit 6B and the second auxiliary connecting circuit 7B are connected to the second power supply side relay 5B. The third main connecting circuit 6C and the third auxiliary connecting circuit 7C are connected to the third power supply side relay 5C.

In detail, the first main connecting circuit 6A is connected to the second main power contact 12A of the first power supply side relay 5A. The second main connecting circuit 6B is connected to the second main power contact 12B of the second power supply side relay 5B. The third main connecting circuit 6C is connected to the second main power contact 12C of the third power supply side relay 5C. The first auxiliary connecting circuit 7A is connected to the second auxiliary power contact 14A of the first power supply side relay 5A. The second auxiliary connecting circuit 7B is connected to the second auxiliary power contact 14B of the second power supply side relay 5B. The third auxiliary connecting circuit 7C is connected to the second auxiliary power contact 14C of the third power supply side relay 5C.

The load side relays 8A-8C are connected to the load circuits 4A-4C, respectively. The load side relays 8A-8C include a first load side relay 8A, a second load side relay 8B, and a third load side relay 8C. The first to third load side relays 8A to 8C each have a 1a1b type contact structure.

The first main connecting circuit 6A and the first auxiliary connecting circuit 7A are connected to the first load side relay 8A. The first load side relay 8A is connected to the first load circuit 4A. The second main connecting circuit 6B and the second auxiliary connecting circuit 7B are connected to the second load side relay 8B. The second load side relay 8B is connected to the second load circuit 4B. The third main connecting circuit 6C and the third auxiliary connecting circuit 7C are connected to the third load side relay 8C. The third load side relay 8C is connected to the third load circuit 4C.

The first load side relay 8A includes a third main power contact 21A, a fourth main power contact 22A, a third auxiliary power contact 23A, a fourth auxiliary power contact 24A, a second movable piece 25A, and a second coil 26A. The third main power contact 21A is connected to the first main connecting circuit 6A. The fourth main power contact 22A is disposed corresponding to the third main power contact 21A. The fourth main power contact 22A is connected to the first load circuit 4A. The third auxiliary power contact 23A is connected to the first auxiliary connecting circuit 7A. The fourth auxiliary power contact 24A is disposed corresponding to the third auxiliary power contact 23A. The fourth auxiliary power contact 24A is connected to the first load circuit 4A.

The second movable piece 25A is movable between a main connection position shown in FIG. 2 and an auxiliary connection position shown in FIG. 3. As shown in FIG. 2, in the main connection position, the second movable piece 25A connects the third main power contact 21A and the fourth main power contact 22A and disconnects the third auxiliary power contact 23A and the fourth auxiliary power contact 24A. As shown in FIG. 3, in the auxiliary connecting position, the second movable piece 25A connects the third auxiliary power contact 23A and the fourth auxiliary power contact 24A and disconnects the third main power contact 21A and the fourth main power contact 22A. The second coil 26A selectively moves the second movable piece 25A between the main connection position and the auxiliary connection position by means of a magnetic force.

The first load side relay 8A is switchable between a main connection state and an auxiliary connection state. When the second movable piece 25A is disposed in the main connection position, the first load side relay 8A is in the main connection state. In the main connection state, the first load side relay 8A connects the third main power contact 21A and the fourth main power contact 22A and disconnects the third auxiliary power contact 23A and the fourth auxiliary power contact 24A. When the second movable piece 25A is disposed in the auxiliary connection position, the first load side relay 8A is in the auxiliary connection state. In the auxiliary connection state, the first load side relay 8A connects the third auxiliary power contact 23A and the fourth auxiliary power contact 24A and disconnects the third main power contact 21A and the fourth main power contact 22A.

The second load side relay 8B and the third load side relay 8C have the same configuration as the first load side relay 8A. In detail, the second load side relay 8B includes a third main power contact 21B, a fourth main power contact 22B, a third auxiliary power contact 23B, a fourth auxiliary power contact 24B, a second movable piece 25B, and a second coil 26B. The third main power contact 21B, the fourth main power contact 22B, the third auxiliary power contact 23B, the fourth auxiliary power contact 24B, the second movable piece 25B, and the second coil 26B of the second load side relay 8B are similar to the third main power contact 21A, the fourth main power contact 22A, the third auxiliary power contact 23A, the fourth auxiliary power contact 24A, the second movable piece 25A, and the second coil 26A of the first load side relay 8A, respectively.

The third load side relay 8C includes a third main power contact 21C, a fourth main power contact 22C, a third auxiliary power contact 23C, a fourth auxiliary power contact 24C, a second movable piece 25C, and a second coil 26C. The third main power contact 21C, the fourth main power contact 22C, the third auxiliary power contact 23C, the fourth auxiliary power contact 24C, the second movable piece 25C, and the second coil 26C of the third load side relay 8C are similar to the third main power contact 21A, the fourth main power contact 22A, the third auxiliary power contact 23A, the fourth auxiliary power contact 24A, the second movable piece 25A, and the second coil 26A of the first load side relay 8A, respectively.

The controller 9 controls the power supply side relays 5A-5C and the load side relays 8A-8C. The controller 9 includes, for example, a processor and a memory. The controller 9 outputs command signals to the first coils 16A-16C of the first to third power supply side relays 5A-5C. Thereby, the controller 9 controls the first to third power supply side relays 5A to 5C, respectively. The controller 9 outputs command signals to the second coils 26A-26C of the first to third load side relays 8A-8C. Thereby, the controller 9 controls the first to third load side relays 8A to 8C, respectively.

As shown in FIG. 1, the controller 9 sets the power supply side relays 5A-5C to the main connection state and sets the load side relays 8A-8C to the main connection state, thereby connecting the main power supply P1 to the loads L1-L3 and disconnecting the auxiliary power supply P2 from the loads L1-L3. Specifically, in the main connection state, the first to third power supply side relays 5A to 5C connect the first to third main power circuits 2A to 2C to the first to third main connecting circuits 6A to 6C, respectively. In the main connection state, the first to third load side relays 8A to 8C connect the first to third main connecting circuits 6A to 6C to the first to third load circuits 4A to 4C, respectively. Thereby, the first to third main power circuits 2A-2C are connected to the first to third load circuits 4A-4C, respectively, and power is supplied from the main power supply P1 to the loads L1-L3.

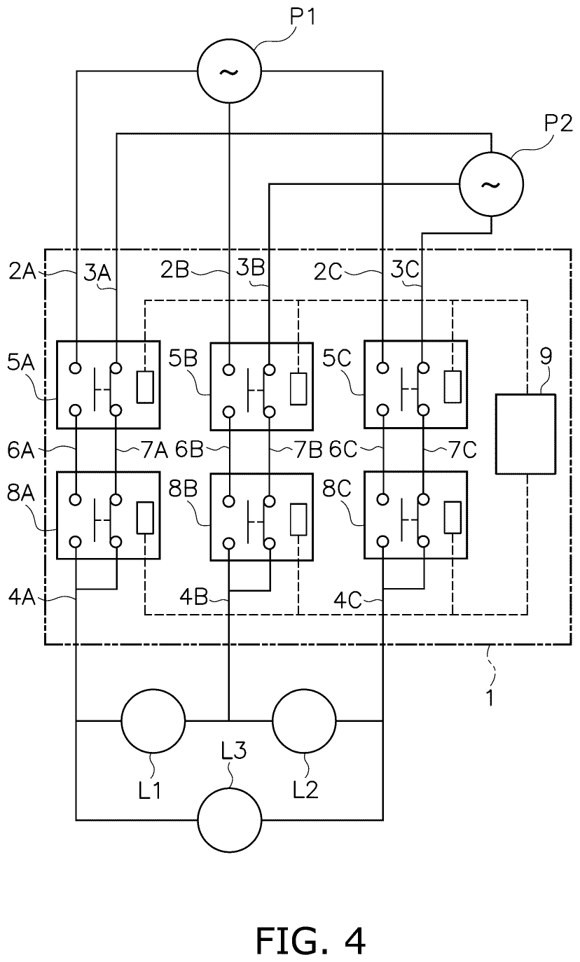

As shown in FIG. 4, the controller 9 switches the power supply side relays 5A-5C to the auxiliary connection state, and switches the load side relays 8A-8C to the auxiliary connection state, thereby connecting the auxiliary power supply P2 to the loads L1-L3 and disconnecting the main power supply P1 from the loads L1-L3. Specifically, as shown in FIG. 4, the first to third power supply side relays 5A to 5C, in the auxiliary connection state, connect the first to third auxiliary power circuits 3A to 3C to the first to third auxiliary connecting circuits 7A to 7C, respectively. In the auxiliary connection state, the first to third load side relays 8A to 8C connect the first to third auxiliary connecting circuits 7A to 7C to the first to third load circuits 4A to 4C, respectively. Thereby, the first to third auxiliary power circuits 3A to 3C are connected to the first to third load circuits 4A to 4C, respectively, and power is supplied from the auxiliary power supply P2 to the loads L1 to L3.

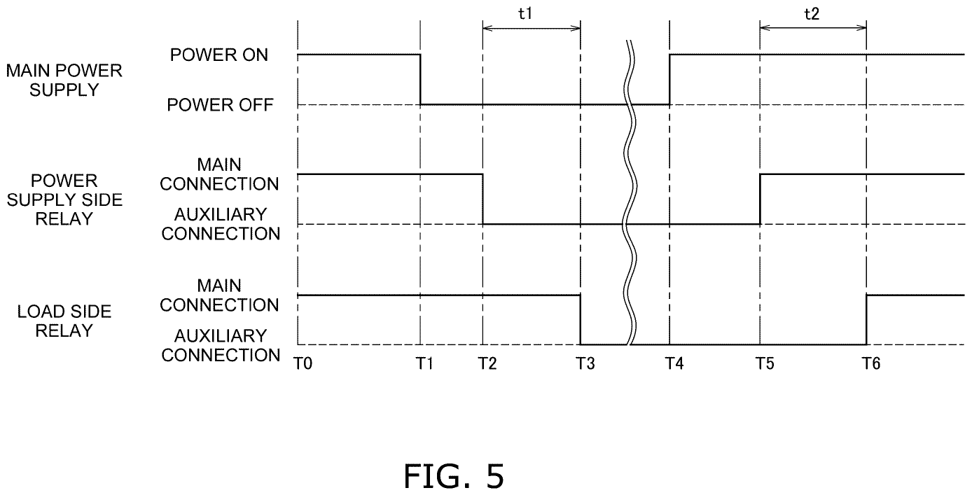

When the main power supply P1 fails, the controller 9 switches the power supply of the loads L1-L3from the main power supply P1 to the auxiliary power supply P2. When the main power supply P1 is restored, the controller 9 switches the power supply of the loads L1-L3 from the auxiliary power supply P2 to the main power supply P1. FIG. 5 is a timing chart showing the control of the power supply side relays 5A-5C and the load side relays 8A-8C when switching the power supply.

As shown in FIG. 5, at time T0, the main power supply P1 is in a conductive state, and the controller 9 sets the power supply side relays 5A-5C and the load side relays 8A-8C to the main connection state. Power is thereby supplied from main power supply P1 through the main power circuits 2A-2C, the main connecting circuits 6A-6C and the load circuits 4A-4C to the loads L1-L3.

When the main power supply P1 fails at time T1, the controller 9 switches the power supply side relays 5A-5C from the main connection state to the auxiliary connection state at time T2. After the controller 9 switches the power supply side relays 5A-5C to the auxiliary connection state, the controller 9 switches the load side relays 8A-8C to the auxiliary connection state at time T3 after a predetermined time t1 has elapsed. Power is thereby supplied from the auxiliary power supply P2 through the auxiliary power circuits 3A-3C, the auxiliary connecting circuits 7A-7C and the load circuits 4A-4C to the loads L1-L3.

When the main power supply P1 is restored to a conductive state at time T4, the controller 9 switches the power supply side relays 5A-5C from the auxiliary connection state to the main connection state at time T5. After the controller 9 switches the power supply side relays 5A-5C to the main connection state, the controller 9 switches the load side relays 8A-8C to the main connection state at time T6 after a predetermined time t2 has elapsed. Power is thereby supplied from the main power supply P1 through the main power circuits 2A-2C, the main connecting circuits 6A-6C and the load circuits 4A-4C to the loads L1-L3. The predetermined time t2 may be the same as the predetermined time t1 or may be different.

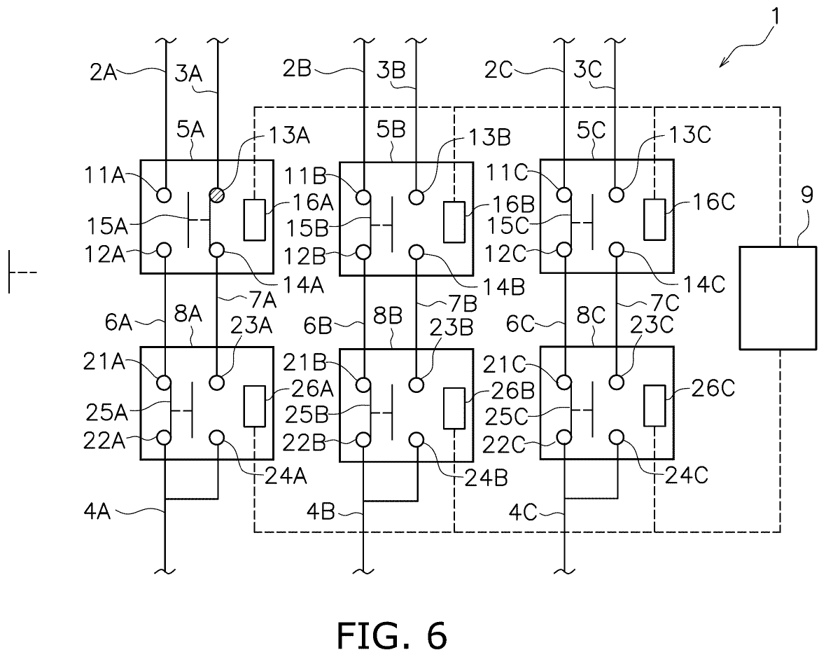

In the power supply switching device 1 according to the present embodiment described above, when the contacts are welded, a short circuit of the power supply is prevented. For example, as shown in FIG. 6, if the first auxiliary power contact 13A of the first power supply side relay 5A is welded when the main power supply P1 is restored, the second power supply side relay 5B, the third power supply side relay 5C, and the first to third load side relays 8A-8C switch to the main connection state, but the first power supply side relay 5A does not switch to the main connection state. In this case, the second main power circuit 2B and the third main power circuit 2C are connected to the second load circuit 4B and the third load circuit 4C, respectively, but the first main power circuit 2A is not connected to the first load circuit 4A. However, the first load side relay 8A is switched to the main connection state, and the first load side relay 8A disconnects the first auxiliary connecting circuit 7A from the first load circuit 4A. Therefore, the first auxiliary power circuit 3A is isolated from the first load circuit 4A, preventing a short circuit between the main power supply P1 and the auxiliary power supply P2. Similarly, even if the second power supply side relay 5B, the third power supply side relay 5C, or the first to third load side relays 8A-8C are welded, a short circuit between the main power supply P1 and the auxiliary power supply P2 is prevented.

The controller 9 switches the power supply side relays 5A-5C to the auxiliary connection state and then switches the load side relays 8A-8C to the auxiliary connection state after a predetermined time t1 has elapsed. Furthermore, after the controller 9 has switched the power supply side relays 5A-5C to the main connection state, the controller 9 switches the load side relays 8A-8C to the main connection state after a predetermined time t2 has elapsed. This suppresses the occurrence of arcs in the power supply side relays 5A-5C.

Although one embodiment of the claimed invention has been described above, the claimed invention is not limited to the above embodiment, and various modifications are possible without departing from the scope of the invention.

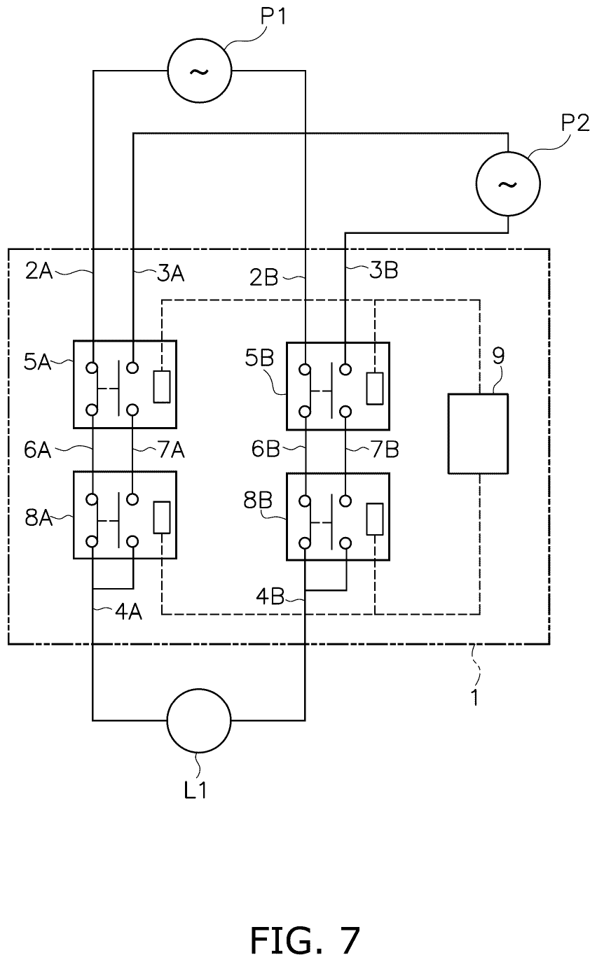

The above-mentioned main power supply P1 and the auxiliary power supply P2 are single-phase three-wire AC power supplies. However, the main power supply P1 and the auxiliary power supply P2 may be of a three-phase, three-wire system. Alternatively, as shown in FIG. 7, the main power supply P1 and the auxiliary power supply P2 may be of a single-phase two-wire system. The second power supply side relay 5B and the second load side relay 8B may be omitted. The main power supply P1 is not limited to a commercial power supply and may be another power supply such as a battery or a generator.

The controller 9 may switch the power supply side relays 5A-5C to the main connection state after a predetermined time has elapsed after switching the load side relays 8A-8C to the main connection state. The controller 9 may switch the power supply side relays 5A-5C to the auxiliary connection state after a predetermined time has elapsed after switching the load side relays 8A-8C to the auxiliary connection state. In this case, the occurrence of arcs in the load side relays 8A-8C is suppressed.

The configuration of the power supply switching device 1 is not limited to that of the above embodiment and may be modified. For example, the controller 9 may be omitted. For example, a switch may be manually pressed to input a command signal to the power supply side relays 5A-5C and the load side relays 8A-8C. This may switch the connection state of the power supply side relays 5A-5C and the connection state of the load side relays 8A-8C.

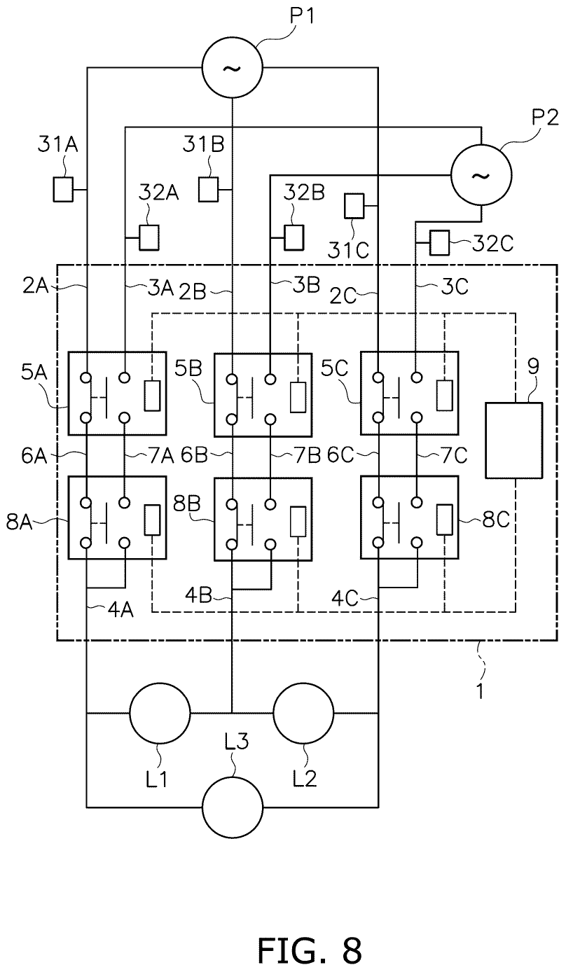

As shown in FIG. 8, the power supply switching device 1 may further include main power sensors 31A-31C and auxiliary power sensors 32A-32C. The main power sensors 31A-31C detect the voltages of the main power circuits 2A-2C, respectively. The controller 9 determines whether any of the first main power contact 11A, the second main power contact 12A, the third main power contact 21A, or the fourth main power contact 22A is welded based on the voltage of the first main power circuit 2A detected by the main power sensor 31A. The controller 9 determines whether any of the first main power contact 11B, the second main power contact 12B, the third main power contact 21B, or the fourth main power contact 22B is welded based on the voltage of the second main power circuit 2B detected by the main power sensor 31B. The controller 9 determines whether any of the first main power contact 11C, the second main power contact 12C, the third main power contact 21C, or the fourth main power contact 22C is welded based on the voltage of the third main power circuit 2C detected by the main power sensor 31C. The main power sensors 31A-31C may detect the currents of the main power circuits 2A-2C, respectively. The controller 9 may determine whether or not a welding has occurred based on the currents in the main power circuits 2A-2C detected by the main power sensors 31A-31C.

The auxiliary power sensors 32A-32C detect the voltages of the auxiliary power circuits 3A-3C, respectively. The controller 9 determines whether any of the first auxiliary power contact 13A, the second auxiliary power contact 14A, the third auxiliary power contact 23A, or the fourth auxiliary power contact 24A is welded based on the voltage of the first auxiliary power circuit 3A detected by the auxiliary power sensor 32A. The controller 9 determines whether any of the first auxiliary power contact 13B, the second auxiliary power contact 14B, the third auxiliary power contact 23B, or the fourth auxiliary power contact 24B is welded based on the voltage of the second auxiliary power circuit 3B detected by the auxiliary power sensor 32B. The controller 9 determines whether any of the first auxiliary power contact 13C, the second auxiliary power contact 14C, the third auxiliary power contact 23C, or the fourth auxiliary power contact 24C is welded based on the voltage of the third auxiliary power circuit 3C detected by the auxiliary power sensor 32C. The auxiliary power sensors 32A-32C may detect the currents in the auxiliary power circuits 3A-3C, respectively. The controller 9 may determine whether welding has occurred based on the currents in the auxiliary power circuits 3A-3C detected by the auxiliary power sensors 32A-3C.

The controller 9 may output an alarm when it determines that welding has occurred in either the main power contact or the auxiliary power contact. The warning is displayed, for example, on a display. Alternatively, the alarm may be output by other means, such as lighting a lamp. Alternatively, the controller 9 may prohibit switching of the power supply when it is determined that welding has occurred in either the main power contact or the auxiliary power contact.

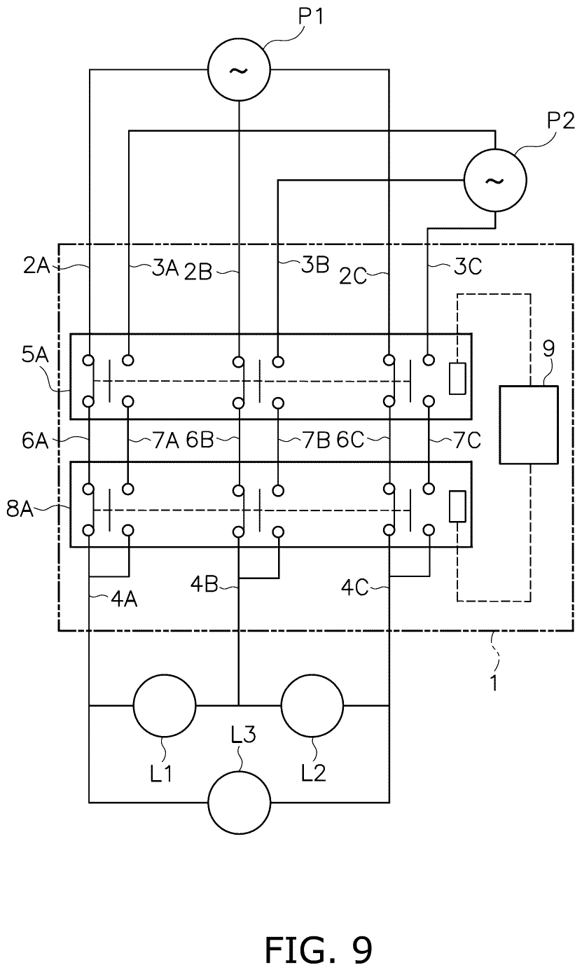

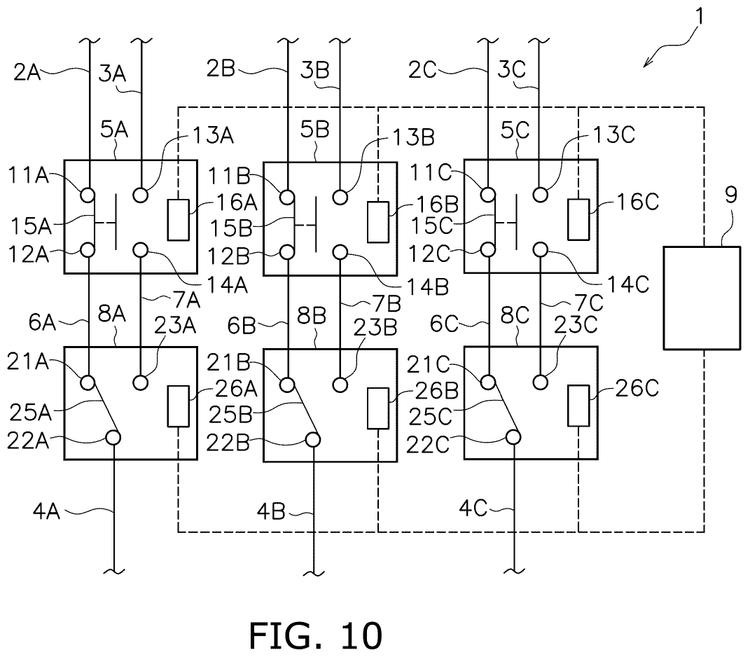

The configurations of the power supply side relays 5A-5C and the load side relays 8A-8C are not limited to those in the above embodiment and may be modified. For example, in the above embodiment, the power supply side relays 5A-5C and the load side relays 8A-8C have a 1a1b type contact structure. However, as shown in FIG. 9, the power supply side relay 5A and the load side relay 8A may have a 3a3b type contact structure. Alternatively, as shown in FIG. 10, the load side relays 8A-8C may have a type 1c contact structure. In the above embodiment, the relay has a double break type contact structure. However, the relay may have a single break type contact structure. The contact may be a separate body from the movable piece, or may be part of the movable piece.

### REFERENCE SIGNS LIST

1: Power supply switching device, 2A: First main power circuit, 3A:
First auxiliary power circuit, 4A: First load circuit, 5A: First power supply side relay, 6A: First main connecting circuit, 7A: First auxiliary connecting circuit, 8A: First load side relay, 9: Controller, 11A: First main power contact, 12A: Second main power contact, 13A: First auxiliary power contact, 14A: Second auxiliary power contact, 21A: Third main power contact, 23A: Third auxiliary power contact, 31A: Main power sensor, 32A: Auxiliary power sensor, L1-L3: Load, P1: Main power supply, P2: Auxiliary power supply

What is claimed is:

1. A power supply switching device that switches a power supply of a load between a main power supply and an auxiliary power supply, the power supply switching device comprising:
a main power circuit connected to the main power supply,
an auxiliary power circuit connected to the auxiliary power supply;
a load circuit connected to the load;
a power supply side relay including a first main power contact connected to the main power circuit, a second main power contact disposed corresponding to the first main power contact, a first auxiliary power contact connected to the auxiliary power circuit, and a second auxiliary power contact disposed corresponding to the first auxiliary power contact, the power supply side relay being switchable between a first main connection state and a first auxiliary connection state, the power supply side relay being configured to, in the first main connection state, connect the first main power contact and the second main power contact and disconnect the first auxiliary power contact and the second auxiliary power contact, the power supply side relay being configured to, in the first auxiliary connection state, connect the first auxiliary power contact and the second auxiliary power contact and disconnect the first main power contact and the second main power contact;
a main connecting circuit connected to the second main power contact;
an auxiliary connecting circuit connected to the second auxiliary power contact; and
a load side relay including a third main power contact connected to the main connecting circuit and a third auxiliary power contact connected to the auxiliary connecting circuit, the load side relay being switchable between a second main connection state and a second auxiliary connection state, the load side relay being configured to connect the third main power contact and the load circuit and disconnects the third auxiliary power contact and the load circuit, the load side relay being configured to, in the second auxiliary connection state, connect the third auxiliary power contact and the load circuit and disconnect the third main power contact and the load circuit.

2. The power supply switching device according to claim 1, further comprising a controller configured to control the power supply side relay and the load side relay.

3. The power supply switching device according to claim 2, wherein
the controller is configured to switch the power supply side relay to the first main connection state and switches the load side relay to the second main connection state to supply power from the main power supply to the load.

4. The power supply switching device according to claim 3, wherein
the controller is configured to switch the load side relay to the second main connection state after a predetermined time has elapsed after switching the power supply side relay to the first main connection state.

5. The power supply switching device according to claim 3, wherein
the controller is configured to switch the power supply side relay to the first main connection state after a predetermined time has elapsed after switching the load side relay to the second main connection state.

6. The power supply switching device according to claim 2, wherein
the controller is configured to switch the power supply side relay to the first auxiliary connection state and switches the load side relay to the second auxiliary connection state to supply power from the auxiliary power supply to the load.

7. The power supply switching device according to claim 6, wherein
the controller is configured to switch the load side relay to the second auxiliary connection state after a predetermined time has elapsed after switching the power supply side relay to the first auxiliary connection state.

8. The power supply switching device according to claim 6, wherein
the controller is configured to switch the power supply side relay to the first auxiliary connection state after a predetermined time has elapsed after switching the load side relay to the second auxiliary connection state.

9. The power supply switching device according to claim 2, further comprising:
a main power sensor configured to detect a voltage or a current of the main power circuit, wherein
the controller is configured to determine whether at least one of the first main power contact, the second main power contact, and the third main power contact is welded based on the voltage or the current of the main power circuit detected by the main power sensor.

10. The power supply switching device according to claim 2, further comprising:
an auxiliary power sensor configured to detect a voltage or a current of the auxiliary power circuit, wherein
the controller is configured to determine whether at least one of the first auxiliary power contact, the second auxiliary power contact, and the third auxiliary power contact is welded based on the voltage or the current of the auxiliary power circuit detected by the auxiliary power sensor.
